(19) United States
(12) Patent Application Publication
(10) Pub. No.: US 2026/0209067 A1
(43) Pub. Date: Jul. 23, 2026

(54) COMPOSITION, METHOD FOR MANUFACTURING COATED ACTIVE MATERIAL, METHOD FOR MANUFACTURING BATTERY, AND BATTERY

(71) Applicant: Panasonic Intellectual Property Management Co., Ltd., Osaka (JP)

(72) Inventors: YOHEI HAYASHI, Osaka (JP); RYUHEI KATAYAMA, Osaka (JP); YOSHIAKI TANAKA, Kyoto (JP)

(21) Appl. No.: 19/571,331

(22) Filed: Mar. 18, 2026

Related U.S. Application Data
(63) Continuation of application No. PCT/JP2024/037470, filed on Oct. 22, 2024.

(30) Foreign Application Priority Data
Dec. 5, 2023 (JP) 2023-205698

(51) Int. Cl. C01G 31/02; H01M 4/02; H01M 4/36; H01M 4/485

(52) U.S. Cl. CPC C01G 31/02; H01M 4/366; H01M 4/485; C01P 2004/84; C01P 2006/40; H01M 2004/027

(57) ABSTRACT

A composition according to an aspect of the present disclosure contains water, lithium hydroxide, at least one organic substance that has no carboxyl group and that dissolves in water, and at least one active material. The percentage of the lithium hydroxide relative to the water is greater than or equal to 10% as a percentage by mass.

### BACKGROUND

### 1. Technical Field

The present disclosure relates to a composition, a method for manufacturing a coated active material, a battery, and a method for manufacturing a battery.

### 2. Description of the Related Art

Japanese Unexamined Patent Application Publication No. 2014-044950 discloses a method for manufacturing a negative electrode active material for lithium secondary batteries in which a solution containing water and a carbon precursor is used.

### SUMMARY

In the related art, there is a need for the development of an active material that has high electronic conductivity and with which battery characteristics can be improved. One non-limiting and exemplary embodiment provides technologies that realize an active material with which charge-discharge capacity of batteries can be improved.

In one general aspect, the techniques disclosed here feature a composition containing water, lithium hydroxide, at least one organic substance that has no carboxyl group and that dissolves in water, and at least one active material, wherein a percentage of the lithium hydroxide relative to the water is greater than or equal to 10% as a percentage by mass.

According to an aspect of the present disclosure, there are provided technologies that realize an active material with which charge-discharge capacity of batteries can be improved.

It should be noted that general or specific embodiments may be implemented as a system, a method, an integrated circuit, a computer program, a storage medium, or any selective combination thereof.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 is a cross-sectional view illustrating a schematic structure of a battery 1000 according to Embodiment 4;

FIG. 2 illustrates a schematic view of a pressure molding die 300 used to evaluate electronic conductivity of active materials; and

FIG. 3 is a graph representing initial charge-discharge characteristics of a battery of Example 1.

### DETAILED DESCRIPTIONS

### Underlying Knowledge Forming Basis of the Present Disclosure

In the related art, the field of secondary batteries faces a demand for higher energy density and higher capacity. A mainstream approach for addressing this demand is the use of an organic electrolyte solution, in which an electrolyte salt is dissolved in an organic solvent. Secondary batteries made using an organic electrolyte solution (hereinafter referred to as “liquid batteries”), however, involve a concern regarding leakage, and it has also been pointed out that such batteries may generate a large amount of heat in the event of, for example, short-circuiting.

Under such circumstances, all-solid-state secondary batteries, in which an inorganic solid electrolyte is used in place of an organic electrolyte solution, have been attracting attention. All-solid-state secondary batteries are free from leakage. Since inorganic solid electrolytes are nonflammable, there are also expectations that such batteries generate only a limited amount of heat in the event of, for example, short-circuiting.

For both liquid batteries and all-solid-state secondary batteries, the use of an electrode material having a high energy density has been studied in order to further improve charge-discharge capacity. Many electrode materials having a high energy density, however, undergo volume expansion and shrinkage in association with charge and discharge, which can cause reduced durability, particularly in all-solid-state secondary batteries.

Lithium oxide materials are active materials that undergo small volume expansion and shrinkage; however, many such materials typically have low electronic conductivity. This type of active material, therefore, is disadvantageous in that the charge-discharge capacity decreases.

To address this, the inventors investigated techniques for increasing electronic conductivity of materials having low electronic conductivity and thereby improving charge-discharge capacity of batteries. Consequently, it was found that by coating the surface of an active material using a solution in which a particular organic substance is dissolved in water containing dissolved lithium hydroxide, the electronic conductivity of the active material can be increased, whereby charge-discharge capacity of batteries can be improved. The foregoing knowledge forms the basis of the present disclosure.

### Embodiment 1

A composition according to Embodiment 1 contains water, lithium hydroxide, at least one organic substance, and at least one active material. The organic substance has no carboxyl group and dissolves in water. In the composition according to Embodiment 1, the percentage of lithium hydroxide relative to water is greater than or equal to 10% as a percentage by mass.

Herein, “an organic substance dissolves in water” means that the solubility of the organic substance in 100 ml of water at 25° C. is higher than or equal to 0.1 g. In this context, dissolution is defined as satisfying both of the following conditions: the solution obtained by dissolving the solute in the solvent in a container is not opaque; and, after the solution is allowed to stand for 24 hours, no precipitate is observed at the bottom of the container. The solubility of the organic substance in 100 ml of water at 25° C. may be higher than or equal to 0.15 g.

The composition may be in the form of a paste or may be in the state of a liquid dispersion. The active material is in the form of, for example, particles. In the composition, the particles of the active material are mixed with water. The viscosity of the composition can be adjusted as appropriate. For example, when the viscosity of the composition is relatively low, it can be possible to remove solvents by drying the composition by methods such as spraying. When the viscosity of the composition is relatively high, it can be possible to remove solvents by drying the composition by methods such as drying under heat.

According to this configuration, there can be provided a composition with which charge-discharge capacity of batteries can be improved. The composition according to an aspect of the present disclosure is suitable for manufacture of an active material member that has high electronic conductivity and with which charge-discharge capacity can be improved. For example, when the composition according to an aspect of the present disclosure is dried, and thereby water is removed, an active material member having high electronic conductivity can be obtained. The active material member can be a coated active material, an active material in the form of particles having a surface coated with an electrically conductive material. Alternatively, the active material member can be an active material membrane containing an active material and an electrically conductive material.

The percentage of lithium hydroxide relative to water may be greater than or equal to 12% as a percentage by mass. The upper limit to the percentage of lithium hydroxide is not particularly limited; for example, the percentage may be less than or equal to 30% as a percentage by mass relative to water.

The percentage of lithium hydroxide in the composition can be measured by, for example, radiofrequency inductively coupled plasma (ICP) emission spectrometry.

Some lithium hydroxide may remain undissolved in the water. That is, the water may be saturated with lithium hydroxide. In such a configuration, the mass of the active material dissolved in the water can be limited.

The organic substance may be a compound having a hydroxy group.

The organic substance may include at least one saccharide. Saccharides have a large number of hydroxy groups in their structure, and thus can become selectively adsorbed onto the surface of the active material and form a favorable coating state. Herein, saccharides include sugar alcohols.

The saccharide may be at least one selected from the group consisting of sucrose, glucose, mannose, fructose, sorbitol, and xylitol.

The saccharide may be at least one saccharide selected from the group consisting of monosaccharides and disaccharides. The saccharide may be disaccharide(s).

The saccharide may include sucrose. By using sucrose, the amount of the organic substance dissolved in the water can be increased.

According to this configuration, there can be provided a composition with which charge-discharge capacity of batteries can be improved.

The organic substance may include at least one polymeric compound.

Examples of polymeric compounds include synthetic resins, polysaccharides, and polyphenols. The polymeric compound may be at least one selected from the group consisting of polyvinyl alcohol, polyvinyl butyral, carboxymethyl cellulose, and ethyl cellulose. These compounds have a large number of hydroxy groups in their structure, and thus can become selectively adsorbed onto the surface of the active material and form a favorable coating state.

According to this configuration, there can be provided a composition with which charge-discharge capacity of batteries can be improved.

In the composition according to Embodiment 1, the percentage of the organic substance may be greater than or equal to 0.2% by mass and less than or equal to 20.0% by mass.

The percentage of the mass of the active material to the total mass of the active material and water is not particularly limited and may be less than or equal to 10% by mass. In such a configuration, a composition that can be easily dried, for example using spraying, can be obtained.

The active material includes a material having the ability to store and release metal ions (e.g., lithium ions). The active material may be a negative electrode active material or may be a positive electrode active material.

The active material may be a negative electrode active material. When this is the case, the composition according to an aspect of the present disclosure can provide a negative electrode active material that has high electronic conductivity and with which charge-discharge capacity can be improved.

The active material may contain element V.

The active material may be a composite oxide containing lithium and vanadium.

The active material may be a compound represented by formula (1) below.

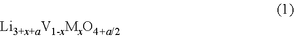

where M is at least one element selected from the group consisting of tetravalent metal elements and tetravalent metalloid elements, and formula (1) satisfies 0≤a<1 and 0≤x<1.

Formula (1) may satisfy 0≤x≤0.15. Thereby, charge-discharge capacity of batteries can be improved.

Formula (1) may satisfy 0<x≤0.15. Thereby, charge-discharge capacity of batteries can be improved.

It should be noted that active materials containing element V (in particular, Li₃₊ₓ₊ₐV₁₋ₓMₓO_{4+a/2}) are readily soluble in solvents having high polarity. By applying an active material containing element V to a composition in which the percentage of lithium hydroxide relative to water is greater than or equal to 10% as a percentage by mass, therefore, drawbacks unique to active materials containing element V can be addressed.

Examples of tetravalent metal elements and tetravalent metalloid elements include Ti, Zr, Si, Ge, and Sn. In formula (1), M may include at least one selected from the group consisting of Ti, Zr, Si, Ge, and Sn. Thereby, charge-discharge capacity of batteries can be improved.

In formula (1), M may include Ti. Thereby, charge-discharge capacity of batteries can be improved.

The shape of the active material is not limited. Examples of the shape include needle-like, spherical, or ellipsoidal shapes. The active material according to Embodiment 1 may be in the form of particles. The active material may be formed to have a pellet or plate shape.

When the shape of the active material is, for example, particulate (e.g., spherical), the active material may have a median diameter of greater than or equal to 0.1 μm and less than or equal to 100 μm. Desirably, the active material may have a median diameter of greater than or equal to 0.5 μm and less than or equal to 10 μm. When this is the case, the composition according to Embodiment 1 can provide an active material having higher lithium diffusivity. When the active material is mixed with another material, such as a solid electrolyte, furthermore, the state of dispersion of the active material and the additional material is favorable. Median diameter refers to a particle diameter in a volume-based particle size distribution at which the cumulative volume is equal to 50%. The volume-based size distribution is measured using, for example, a laser diffraction analyzer or an image analyzer.

The composition according to Embodiment 1 may further contain substances other than those described above. For example, the composition may contain a binder. By incorporating a binder, binding between particles can be enhanced when the composition is dried as described later.

Examples of binders include polyvinylidene fluoride, polytetrafluoroethylene, polyethylene, polypropylene, aramid resins, polyamides, polyimides, polyamide-imides, polyacrylonitrile, polyacrylic acid, polymethyl acrylate, polyethyl acrylate, polyhexyl acrylate, polymethacrylic acid, polymethyl methacrylate, polyethyl methacrylate, polyhexyl methacrylate, polyvinyl acetate, polyvinylpyrrolidone, polyethers, polyethersulfones, hexafluoropolypropylene, styrene butadiene rubber, or carboxymethyl cellulose. Copolymers can also be used as binders. Examples of such binders include copolymers of two or more materials selected from the group consisting of tetrafluoroethylene, hexafluoroethylene, hexafluoropropylene, perfluoroalkyl vinyl ethers, vinylidene fluoride, chlorotrifluoroethylene, ethylene, propylene, pentafluoropropylene, fluoromethyl vinyl ether, acrylic acid, and hexadiene. A mixture of two or more materials selected from these may be used as a binder.

The pH of the composition according to Embodiment 1 may be, for example, higher than or equal to 13 or may be higher than or equal to 14. In this configuration, it can be possible to limit decomposition of the active material and collapse of the structure.

### Embodiment 2

Embodiment 2 will now be described. Descriptions that are the same as in Embodiment 1 above will be omitted where appropriate.

A method according to Embodiment 2 for manufacturing a coated active material includes:
(A) drying a composition according to Embodiment 1.

By removing the water by drying the composition, a coated active material homogeneously coated with the organic substance, for example, can be manufactured. As a result, the coated active material has high electronic conductivity. Such a coated active material can be used to obtain a battery having excellent charge-discharge characteristics. The coated active material manufactured by the manufacturing method according to Embodiment 2 is suitable for, for example, improving capacity of batteries. An example of a battery is an all-solid-state battery. The all-solid-state battery may be a primary battery or may be a secondary battery.
(A) is performed by, for example, heating the composition. The heating temperature may be, for example, higher than or equal to 50° C. and lower than or equal to 200° C. The duration of heating may be, for example, longer than or equal to 30 minutes and shorter than or equal to 24 hours. The drying may be performed under atmospheric pressure or may be drying under reduced pressure. That is, the water may be removed by drying under reduced pressure.

Drying under reduced pressure refers to drying the composition in an atmosphere at a pressure lower than atmospheric pressure. The atmosphere at a pressure lower than atmospheric pressure can have, for example, a gauge pressure of lower than or equal to-0.01 MPa. During the drying under reduced pressure, the composition may be heated to, for example, higher than or equal to 50° C. and lower than or equal to 200° C.

The water may be removed by vacuum drying. Vacuum drying refers to, for example, drying the composition at or below the vapor pressure of a compound at a temperature 20° C. lower than the boiling point of the compound and thereby removing the compound.

The removal of water can be confirmed by, for example, Fourier-transform infrared spectroscopy (FT-IR), X-ray photoelectron spectroscopy (XPS), gas chromatography (GC), or gas chromatography-mass spectrometry (GC/MS). It should be noted that herein, removing water means applying a treatment for removing water, such as drying the composition, and does not mean completely removing all of the water. That is, as long as the coated active material obtained after the drying has electronic conductivity, the water does not need to be completely removed.

The method according to Embodiment 2 for manufacturing a coated active material may further include:
(B) carbonizing the organic substance by heat treatment.

By carbonizing the organic substance, active material particles homogeneously coated with electrically conductive carbon can be manufactured.

The temperature for the heat treatment is not particularly limited as long as it is a temperature at which the organic substance carbonizes. For example, it may be higher than or equal to 500° C. and lower than or equal to 900° C. The duration of the heat treatment may be longer than or equal to 3 hours and shorter than or equal to 72 hours. The heat treatment may be performed in a vacuum atmosphere or in an inert atmosphere. The inert atmosphere may be, for example, a nitrogen atmosphere or an argon atmosphere. In the method according to Embodiment 2 for manufacturing a coated active material, (B) may be performed after (A). That is, the organic substance may be carbonized by heat-treating the composition after the composition is dried. (A) and (B) may be performed consecutively, or another treatment may be performed between (A) and (B). For example, after (A) and before (B), crushing of the dried composition may be performed.
(A) and (B) may be performed simultaneously. The drying of the composition and the carbonization of the organic substance may be performed by heat treatment of the composition according to Embodiment 1.

In (A), the composition may be first brought into a state of coated particles in which an aqueous solution containing water, the organic substance that dissolves in water, and lithium hydroxide (hereinafter referred to as “the aqueous solution component of the composition”) coats at least part of the surface of particles of the active material, after which these coated particles may be dried to remove the water. By filtering the composition according to Embodiment 1, for example, such coated particles, in which an appropriate amount of the aqueous solution component of the composition coats at least part of the surface of particles of the active material, can be obtained as a solid-containing residue.

That is, the method according to Embodiment 2 for manufacturing a coated active material may include:
(A1) filtering a composition according to Embodiment 1 and thereby obtaining coated particles in which the aqueous solution component of the composition coats at least part of the surface of particles of the active material;
(A2) drying the coated particles; and
(B) carbonizing the organic substance by heat treatment.

According to the foregoing, a coated active material having a surface homogeneously coated with an appropriate amount of the organic substance can be manufactured. Thereby, an active material can be manufactured that has high electronic conductivity and with which the charge-discharge capacity of batteries can be further improved. Removing excess water in advance, furthermore, facilitates subsequent removal of water by drying.
(A1) and (A2) may be performed consecutively, or another treatment may be performed between (A1) and (A2). (A2) and (B) may be performed consecutively, or another treatment may be performed between (A2) and (B). For example, after (A2) and before (B), crushing of the dried coated particles may be performed. Alternatively, (A2) and (B) may be performed simultaneously.

### Embodiment 3

A method according to Embodiment 3 for manufacturing a battery is a method for manufacturing a battery including a first electrode, a second electrode, and an electrolyte layer disposed between the first electrode and the second electrode. The method according to Embodiment 3 for manufacturing a battery includes:
(A) drying a composition according to Embodiment 1; and
(B) carbonizing the organic substance by heat treatment in forming the first electrode.

According to the foregoing, a battery including a coated active material having high electronic conductivity can be manufactured. In the method according to Embodiment 3 for manufacturing a battery, therefore, a battery having high charge-discharge characteristics can be manufactured.

When the active material in the composition is a negative electrode active material, the first electrode becomes a negative electrode. When the active material in the composition is a positive electrode active material, the first electrode becomes a positive electrode.

The method according to Embodiment 3 for manufacturing a battery may further include obtaining a coated active material through a process including (A) and (B) above, and preparing an electrode material containing this coated active material.

In the method according to Embodiment 3 for manufacturing a battery, the first electrode may be formed by layering the electrode material on a current collector. Alternatively, in the method according to Embodiment 3 for manufacturing a battery, the first electrode may be formed by layering the electrode material on the electrolyte layer after the electrolyte layer is formed. The electrolyte layer may be formed by layering a solid electrolyte material.

The electrode material may be prepared by mixing the coated active material described above and a solid electrolyte material. Examples of solid electrolyte materials include sulfide solid electrolytes, oxide solid electrolytes, halide solid electrolytes, or organic polymer solid electrolytes.

Examples of sulfide solid electrolytes include Li₂S—P₂S₅, Li₂S—SiS₂, Li₂S—B₂S₃, Li₂S—GeS₂, Li_{3.25}Ge_{0.25}P_{0.75}S₄, or Li₁₀GeP₂S₁₂.

Examples of oxide solid electrolytes include:
(i) NASICON solid electrolytes, such as LiTi₂(PO₄)₃ or substituted derivatives thereof;
(ii) perovskite solid electrolytes, such as (LaLi)TiO₃;
(iii) LISICON solid electrolytes, such as Li₁₄ZnGe₄O₁₆, Li₄SiO₄, LiGeO₄, or substituted derivatives thereof;
(iv) garnet solid electrolytes, such as Li₇La₃Zr₂O₁₂ or substituted derivatives thereof; or
(v) Li₃PO₄ or N-substituted derivatives thereof.

Examples of halide solid electrolytes include Li₂MgX′₄, Li₂FeX′₄, Li(Al,Ga,In) X′₄, Li₃(Al,Ga,In) X′₆, or LiX′.

Other examples of halide solid electrolytes include compounds represented by LiₚMe_{q}YZ₆. In this formula, p+m′q+3r=6 and r>0 are satisfied. Me is at least one element selected from the group consisting of metal elements and metalloid elements other than Li and Y. The value of m′ represents the valence of Me. Z is at least one selected from the group consisting of F, Cl, Br, and I. The “metalloid elements” are B, Si, Ge, As, Sb, and Te. The “metal elements” are all elements in groups 1 to 12 of the periodic table (excluding hydrogen) and all elements in groups 13 to 16 of the periodic table (excluding B, Si, Ge, As, Sb, Te, C, N, P, O, S, and Se). To increase the ionic conductivity of the halide solid electrolyte, Me may be at least one selected from the group consisting of Mg, Ca, Sr, Ba, Zn, Sc, Al, Ga, Bi, Zr, Hf, Ti, Sn, Ta, and Nb.

Examples of organic polymer solid electrolytes include compounds formed from a polymeric compound and at least one lithium salt.

The polymeric compound may have an ethylene oxide structure. A polymeric compound having an ethylene oxide structure can contain a large amount of lithium salt. With such a compound, therefore, ionic conductivity can be increased.

Examples of lithium salts include LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), or LiC(SO₂CF₃)₃. One lithium salt selected from these may be used alone. Alternatively, a mixture of two or more lithium salts selected from these may be used.

The electrode material may contain, in addition to the coated active material described above, a material capable of storing and releasing metal ions (e.g., lithium ions). When the active material in the composition is a negative electrode active material, the electrode material may further contain another negative electrode active material.

Examples of negative electrode active materials include, in addition to the materials described in Embodiment 1, metal materials, carbon materials, oxides, nitrides, tin compounds, or silicon compounds. A metal material may be a pure metal material or may be an alloy. Examples of metal materials include lithium metal or lithium alloys. Examples of carbon materials include natural graphite, coke, graphitizing carbon, carbon fibers, spherical carbon, artificial graphite, or amorphous carbon. Examples of negative electrode active materials from the viewpoint of capacity density include silicon (i.e., Si), tin (i.e., Sn), silicon compounds, or tin compounds. By using an active material having a low average discharge voltage, such as graphite, as a negative electrode active material, the energy density of the battery can be improved.

The electrode material may further contain a conductive additive to increase electronic conductivity.

Examples of conductive additives include:
(i) graphites, such as natural graphite or artificial graphite;
(ii) carbon blacks, such as acetylene black or Ketjenblack;
(iii) electrically conductive fibers, such as carbon fibers or metal fibers;
(iv) fluorinated carbon;
(v) metallic powders, for example of aluminum;
(vi) electrically conductive whiskers, for example of zinc oxide or potassium titanate;
(vii) electrically conductive metal oxides, such as titanium oxide; or
(viii) electrically conductive polymeric compounds, such as polyaniline, polypyrrole, or polythiophene. A conductive additive of (i) or (ii) above may be used for cost reduction.

For the purpose of facilitating lithium ion transfer and improving power characteristics of the battery, the electrode material may contain a nonaqueous electrolyte solution, a gel electrolyte, or an ionic liquid.

A nonaqueous electrolyte solution contains at least one nonaqueous solvent and at least one lithium salt dissolved in the nonaqueous solvent.

Examples of nonaqueous solvents include cyclic carbonate solvents, linear carbonate solvents, cyclic ether solvents, linear ether solvents, cyclic ester solvents, linear ester solvents, or fluorinated solvents. Examples of cyclic carbonate solvents include ethylene carbonate, propylene carbonate, or butylene carbonate. Examples of linear carbonate solvents include dimethyl carbonate, ethyl methyl carbonate, or diethyl carbonate. Examples of cyclic ether solvents include tetrahydrofuran, 1,4-dioxane, or 1,3-dioxolane. Examples of linear ether solvents include 1,2-dimethoxyethane or 1,2-diethoxyethane. Examples of cyclic ester solvents include γ-butyrolactone. Examples of linear ester solvents include methyl acetate. Examples of fluorinated solvents include fluoroethylene carbonate, methyl fluoropropionate, fluorobenzene, fluoroethyl methyl carbonate, or fluorodimethylene carbonate. One nonaqueous solvent selected from these may be used alone. Alternatively, a mixture of two or more nonaqueous solvents selected from these may be used.

Examples of lithium salts include LiPF₆, LiBF₄, LiSbF₆, LiAsF₆, LiSO₃CF₃, LiN(SO₂CF₃)₂, LiN(SO₂C₂F₅)₂, LiN(SO₂CF₃)(SO₂C₄F₉), or LiC(SO₂CF₃)₃. One lithium salt selected from these may be used alone. Alternatively, a mixture of two or more lithium salts selected from these may be used.

The concentration of the lithium salt may be, for example, greater than or equal to 0.5 mol/liter and less than or equal to 2 mol/liter.

A gel electrolyte can be a polymeric material impregnated with a nonaqueous electrolyte solution. Examples of polymeric materials include polyethylene oxide, polyacrylonitrile, polyvinylidene fluoride, polymethyl methacrylate, or polymers having ethylene oxide linkages.

Examples of cations that can be contained in an ionic liquid include:
(i) aliphatic linear quaternary salts, such as tetraalkylammoniums or tetraalkylphosphoniums;
(ii) aliphatic cyclic ammoniums, such as pyrrolidiniums, morpholiniums, imidazoliniums, tetrahydropyrimidiniums, piperaziniums, or piperidiniums; or
(iii) nitrogen-containing heterocyclic aromatic cations, such as pyridiniums or imidazoliums.

Examples of anions that can be contained in an ionic liquid include PF₆⁻, BF₄⁻, SbF₆⁻, AsF₆⁻, SO₃CF₃⁻, N(SO₂CF₃)₂⁻, N(SO₂C₂F₅)₂⁻, N(SO₂CF₃)(SO₂C₄F₉)⁻, or C(SO₂CF₃)₃⁻.

An ionic liquid may contain a lithium salt.

The electrode material may contain a binder to enhance adhesion between particles. Examples of binders that can be used include the materials mentioned above in Embodiment 1.

### Embodiment 4

Embodiment 4 of an aspect of the present disclosure will now be described. Matters described in Embodiments 1 to 3 will be omitted where appropriate.

A battery according to Embodiment 4 includes a first electrode, a second electrode, and an electrolyte layer. The electrolyte layer is disposed between the first electrode and the second electrode. The first electrode contains a composition according to Embodiment 1. That is, the battery according to Embodiment 4 includes water, lithium hydroxide, at least one organic substance that has no carboxyl group and that dissolves in water, and at least one active material, and the percentage of the lithium hydroxide relative to the water is greater than or equal to 12% as a percentage by mass. The battery according to Embodiment 4 has high charge-discharge characteristics.

When the composition contained in the first electrode contains a negative electrode active material, the first electrode is a negative electrode, and the second electrode is a positive electrode. When the composition contained in the first electrode contains a positive electrode active material, the first electrode is a positive electrode, and the second electrode is a negative electrode.

The second electrode may contain or may be free of a composition according to Embodiment 1. For example, when the first electrode is a negative electrode and the second electrode is a positive electrode, the first electrode may contain a composition according to Embodiment 1 containing a negative electrode active material, and the second electrode may contain a composition according to Embodiment 1 containing a positive electrode active material.

The first electrode may further contain a conductive additive.

The battery according to Embodiment 4 may be manufactured by, for example, a method according to Embodiment 3 for manufacturing a battery.

A specific example of a battery will now be described. In the following, an example in which the first electrode is a negative electrode and the second electrode is a positive electrode will be described.

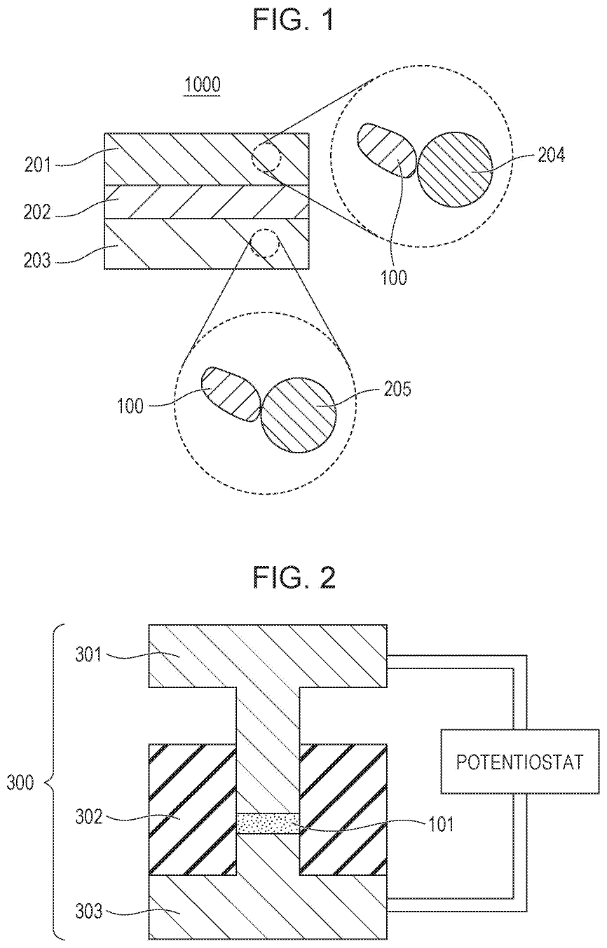

FIG. 1 illustrates a cross-sectional view of a battery 1000 according to Embodiment 4.

The battery 1000 includes a positive electrode 201, an electrolyte layer 202, and a negative electrode 203.

The positive electrode 201 contains positive electrode active material particles 204 and solid electrolyte particles 100.

The electrolyte layer 202 is disposed between the positive electrode 201 and the negative electrode 203.

The electrolyte layer 202 contains an electrolyte material (e.g., a solid electrolyte material).

The negative electrode 203 contains a composition according to Embodiment 1. For example, the negative electrode 203 contains negative electrode active material particles 205, water (not illustrated), lithium hydroxide (not illustrated), an organic substance (not illustrated), and solid electrolyte particles 100, and the negative electrode active material particles 205 contain a coated active material. The organic substance dissolves in water and has no carboxyl group. The coated active material includes a negative electrode active material and at least one coating material that coats at least part of the surface of the negative electrode active material.

The coated active material is, for example, a coated active material manufactured by a manufacturing method according to Embodiment 2.

The negative electrode active material may be, for example, an active material as described above in Embodiment 1.

The coating material may include, for example, an electrically conductive material. The electrically conductive material may be one obtained by carbonizing the organic substance. The coating material can include the organic substance in addition to the conductive material.

The negative electrode active material particles 205 may be particles containing the coated active material as their main component. Particles containing the coated active material as their main component refers to particles in which the coated active material is the most abundant component in terms of ratio by mass. The negative electrode active material particles 205 may be particles formed solely of the coated active material.

The positive electrode 201 contains a material capable of storing and releasing metal ions (e.g., lithium ions). This material is, for example, a positive electrode active material (e.g., positive electrode active material particles 204).

Examples of positive electrode active materials include lithium-containing transition metal oxides, transition metal fluorides, polyanion materials, fluorinated polyanion materials, transition metal sulfides, transition metal oxyfluorides, transition metal oxysulfides, or transition metal oxynitrides. Examples of lithium-containing transition metal oxides include Li(Ni,Co,Al)O₂, LiCoO₂, or Li(Ni,Co,Mn)O₂. An example of a positive electrode active material from the viewpoint of battery energy density is Li(Ni,Co,Mn)O₂. Li(Ni,Co,Mn)O₂ can be charged and discharged at a potential of higher than or equal to 4 V. Herein, “(A,B,C)” represents “at least one selected from the group consisting of A, B, and C.” In this context, A, B, and C each represent an element.

The positive electrode active material particles 204 may have a median diameter greater than or equal to 0.1 μm and less than or equal to 100 μm. When the positive electrode active material particles 204 have a median diameter of greater than or equal to 0.1 μm, the positive electrode active material particles 204 and the solid electrolyte particles 100 can disperse well in the positive electrode 201. As a result, the charge-discharge characteristics of the battery improve. When the positive electrode active material particles 204 have a median diameter of less than or equal to 100 μm, the lithium diffusion rate within the positive electrode active material particles 204 improves. As a result, the battery can operate at high power.

The positive electrode active material particles 204 may have a median diameter larger than that of the solid electrolyte particles 100. When this is the case, the positive electrode active material particles 204 and the solid electrolyte particles 100 can disperse well.

To increase the energy density and power of the battery, the ratio of the volume of the positive electrode active material particles 204 to the total volume of the positive electrode active material particles 204 and the solid electrolyte particles 100 in the positive electrode 201 may be greater than or equal to 0.30 and less than or equal to 0.95.

To increase the energy density and power of the battery, the positive electrode 201 may have a thickness of greater than or equal to 10 μm and less than or equal to 500 μm.

The electrolyte layer 202 contains an electrolyte material. The electrolyte material is, for example, a solid electrolyte material. The electrolyte layer 202 may be a solid electrolyte layer.

The electrolyte layer 202 may be composed solely of a solid electrolyte material. Examples of solid electrolyte materials include the materials mentioned above in Embodiment 3.

The electrolyte layer 202 may have a thickness of greater than or equal to 1 μm and less than or equal to 100 μm. When the electrolyte layer 202 has a thickness of greater than or equal to 1 μm, the positive electrode 201 and the negative electrode 203 are less likely to short-circuit. When the electrolyte layer 202 has a thickness of less than or equal to 100 μm, the battery can operate at high power.

The negative electrode 203 may contain, in addition to the coated active material, a material capable of storing and releasing metal ions (e.g., lithium ions). This material is, for example, a negative electrode active material.

The negative electrode active material can be, for example, a negative electrode active material as described above in Embodiment 3.

The negative electrode active material particles 205 may have a median diameter of greater than or equal to 0.1 μm and less than or equal to 100 μm. When the negative electrode active material particles 205 have a median diameter of greater than or equal to 0.1 μm, the state of dispersion of the negative electrode active material particles 205 and the solid electrolyte particles 100 in the negative electrode 203 improves. As a result, the charge-discharge characteristics of the battery improve. When the negative electrode active material particles 205 have a median diameter of less than or equal to 100 μm, the lithium diffusion rate within the negative electrode active material particles 205 improves. As a result, the battery can operate at high power.

The negative electrode active material particles 205 may have a median diameter larger than that of the solid electrolyte particles 100. When this is the case, the state of dispersion of the negative electrode active material particles 205 and the solid electrolyte particles 100 in the negative electrode 203 is favorable.

To increase the energy density and power of the battery, the ratio of the volume of the negative electrode active material particles 205 to the total volume of the negative electrode active material particles 205 and the solid electrolyte particles 100 in the negative electrode 203 may be greater than or equal to 0.30 and less than or equal to 0.95.

To increase the energy density and power of the battery, the negative electrode 203 may have a thickness of greater than or equal to 10 μm and less than or equal to 500 μm.

The solid electrolyte particles 100 can be particles of, for example, a solid electrolyte material as mentioned above in Embodiment 3.

At least one selected from the group consisting of the positive electrode 201, the electrolyte layer 202, and the negative electrode 203 may contain a nonaqueous electrolyte solution, a gel electrolyte, or an ionic liquid for the purpose of facilitating lithium ion transfer and improving the power characteristics of the battery. The nonaqueous electrolyte solution, gel electrolyte, or ionic liquid can be, for example, a material as described above in Embodiment 3.

At least one selected from the group consisting of the positive electrode 201, the electrolyte layer 202, and the negative electrode 203 may contain a binder to enhance adhesion between particles. The binder can be, for example, a binder as described above in Embodiment 3.

Examples of shapes of the battery according to Embodiment 4 include a coin shape, a cylindrical shape, a prismatic shape, a sheet shape, a button shape, a flat shape, or a multilayer shape.

The battery according to Embodiment 4 may be manufactured by, for example, preparing materials for forming the positive electrode, materials for forming the electrolyte layer, and materials for forming the negative electrode, and producing, by a known method, a multilayer body in which the positive electrode, the electrolyte layer, and the negative electrode are arranged in this order. In this case, at least one selected from the group consisting of the materials for forming the positive electrode and the materials for forming the negative electrode includes a composition according to Embodiment 1.

### OTHER EMBODIMENTS

### Appendix

By the above description of embodiments, the following technologies are disclosed.

### Technology 1

A composition containing:
water;
lithium hydroxide;
at least one organic substance that has no carboxyl group and that dissolves in water; and
at least one active material, wherein:
a percentage of the lithium hydroxide relative to the water is greater than or equal to 10% as a percentage by mass.

With this configuration, there can be realized an active material with which charge-discharge capacity of batteries can be improved.

### Technology 2

The composition according to Technology 1, wherein the organic substance includes at least one saccharide. According to such a configuration, there can be realized an active material with which charge-discharge capacity of batteries can be improved. Technology 3

The composition according to Technology 2, wherein the saccharide is at least one saccharide selected from the group consisting of monosaccharides and disaccharides. According to such a configuration, there can be realized an active material with which charge-discharge capacity of batteries can be improved.

### Technology 4

The composition according to any one of Technologies 1 to 3, wherein the organic substance includes at least one polymeric compound. According to such a configuration, there can be realized an active material with which charge-discharge capacity of batteries can be improved.

### Technology 5

The composition according to Technology 4, wherein the polymeric compound is at least one selected from the group consisting of polyvinyl alcohol, polyvinyl butyral, carboxymethyl cellulose, and ethyl cellulose. According to such a configuration, there can be realized an active material with which charge-discharge capacity of batteries can be improved.

### Technology 6

The composition according to any one of Technologies 1 to 5, wherein the active material contains element V. According to such a configuration, there can be realized an active material with which charge-discharge capacity of batteries can be improved. Technology 7

The composition according to any one of Technologies 1 to 6, wherein the active material is a compound represented by formula (1):

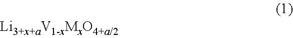

where:
the M is at least one element selected from the group consisting of tetravalent metal elements and tetravalent metalloid elements; and
the formula (1) satisfies 0≤a<1 and 0≤x<1. Compounds represented by formula (1) are suitable for improving charge-discharge characteristics of batteries. According to such a configuration, therefore, the charge-discharge capacity of batteries can be further improved.

### Technology 8

The composition according to Technology 7, wherein the formula (1) satisfies 0≤x≤0.15. According to such a configuration, it can be possible to further improve the charge-discharge capacity of batteries.

### Technology 9

The composition according to Technology 7 or 8, wherein the M includes Ti. According to such a configuration, it can be possible to further improve the charge-discharge capacity of batteries.

### Technology 10

A method for manufacturing a coated active material, the method including:
(A) drying the composition according to any one of Technologies 1 to 9.

According to such a configuration, there can be provided a coated active material with which charge-discharge capacity of batteries can be improved.

### Technology 11

The method according to Technology 10 for manufacturing a coated active material, the method further including:
(B) carbonizing the organic substance by heat treatment. According to such a configuration, there can be provided a coated active material with which charge-discharge capacity of batteries can be improved.

### Technology 12

A method for manufacturing a battery including
a first electrode,
a second electrode, and
an electrolyte layer disposed between the first electrode and the second electrode,
the method including:
(A) drying the composition according to any one of Technologies 1 to 9; and
(B) carbonizing the organic substance by heat treatment
in forming the first electrode.

According to such a configuration, there can be provided a battery having excellent charge-discharge characteristics.

### Technology 13

A battery including:
a first electrode;
a second electrode; and
an electrolyte layer disposed between the first electrode and the second electrode, wherein:
the first electrode contains the composition according to any one of Technologies 1 to 9.

According to such a configuration, the battery can have excellent charge-discharge characteristics.

### Technology 14

The battery according to Technology 13, wherein the first electrode further contains a conductive additive. According to such a configuration, the first electrode has high electronic conductivity, and, as a result, the battery has excellent charge-discharge characteristics.

### EXAMPLES

The details of certain aspects of the present disclosure will now be described using examples and comparative examples.

### Example 1

### Preparation of a Coated Active Material

A 5.0 mol/L aqueous solution of lithium hydroxide was prepared by dissolving 9.6 g of lithium hydroxide in 80 mL of water. By dissolving 2.9 g of sucrose in this aqueous solution of lithium hydroxide, a solution was prepared. It should be noted that the solubility of sucrose in 100 ml of water at 25° C. is approximately 200 g. The pH of this solution was 14. By immersing 1 g of powder of a negative electrode active material Li₃VO₄ (hereinafter referred to as LVO) in this solution, a slurry was obtained. After the slurry was stirred for approximately 30 minutes, filtration using a membrane filter having a pore size of 1 μm was performed, whereby LVO powder with the solution adhering to its surface was obtained. The resulting LVO powder was dried under atmospheric pressure at 80° C. for 2 hours and then crushed. Subsequently, the crushed LVO powder was heat-treated at 600° C. for 24 hours under a vacuum atmosphere of lower than or equal to 0.2 Pa, whereby sucrose present on the surface of the powder of LVO was carbonized. By crushing the heat-treated powder in a mortar, a coated active material was obtained as an active material sample of Example 1.

### Measurement of Electronic Conductivity

FIG. 2 illustrates a schematic view of a pressure molding die 300 used to evaluate electronic conductivity of active materials.

The pressure molding die 300 included an upper punch 301, a die 302, and a lower punch 303. The die 302 was formed of electrically insulating polycarbonate. The upper punch 301 and the lower punch 303 were formed of stainless steel having electronic conductivity.

Using a pressure molding die 300 as illustrated in FIG. 2, electronic conductivity of the coated active material of Example 1 was measured by the following method.

In a dry argon atmosphere, the active material sample of Example 1 (i.e., the sample 101 in FIG. 2) was loaded into the pressure molding die 300. Inside the pressure molding die 300, a pressure of 720 MPa was applied to the active material sample of Example 1 using the upper punch 301 and the lower punch 303.

While the pressure was applied, the upper punch 301 and the lower punch 303 were connected to a potentiostat (BioLogic, VSP-300) equipped with a frequency response analyzer. The upper punch 301 was connected to a working electrode and a potential measurement terminal. The lower punch 303 was connected to a counter electrode and a reference electrode. The electronic conductivity of the active material sample was measured at room temperature by direct current measurement.

Using the resistance value, electronic conductivity was calculated based on equation (2) below.

$$σ = {( {R}_{E} \times S / t )}^{- 1} \qquad ( 2 )$$

In the equation, o represents electronic conductivity. S represents the area of contact between the sample and the upper punch 301 (in FIG. 2, equal to the cross-sectional area of the hollow portion of the die 302). RE represents the resistance value of the active material sample in direct current measurement. t represents the thickness of the coated active material under applied pressure (in FIG. 2, equal to the thickness of the layer formed by the sample 101).

The electronic conductivity of the active material sample of Example 1 measured at 25° C. was 9.00×10⁻² S/cm.

### Preparation of a Sulfide Solid Electrolyte

In an argon glove box having a dew point of lower than or equal to −60° C., powders of Li₂S and P₂S₅, which were raw material powders, were weighed out such that Li₂S:P₂S₅=0.750:0.250 as a molar ratio. These raw material powders were ground and mixed in an agate mortar. In such a manner, a mixture was obtained. Then the mixture was subjected to milling treatment using a planetary ball mill (manufactured by Fritsch GmbH; P-7) under conditions of 500 rpm for 12 hours. As a result of this, a glassy solid electrolyte was obtained. Subsequently, in a glove box having a dew point of lower than or equal to −60° C., the glassy solid electrolyte was heat-treated at 270° C. for 2 hours using a heat-treatment furnace. In such a manner, powder of Li₂S—P₂S₅ (hereinafter referred to as LPS), which is a glass-ceramic solid electrolyte, was obtained as a sulfide solid electrolyte.

### Preparation of a Negative Electrode Material

In an argon glove box having a dew point of lower than or equal to −60° C., the active material sample of Example 1 and LPS were weighed out such that the ratio by volume between LVO and LPS was 0.650:0.350. By mixing these materials in an agate mortar, a negative electrode material of Example 1 was prepared.

### Fabrication of a Secondary Battery

LPS (94.0 mg) was placed into an electrically insulating cylinder having an inner diameter of 9.50 mm. A pressure of 80 MPa was applied, whereby a solid electrolyte layer was formed.

Then the negative electrode material of Example 1 (6.27 mg) was layered on the solid electrolyte layer formed from LPS, whereby a multilayer body was obtained. A pressure of 720 MPa was applied to this multilayer body, whereby a negative electrode was formed.

Subsequently, a metallic Li foil (thickness, 300 μm) was placed on the solid electrolyte layer formed from LPS, whereby a multilayer body was obtained. A pressure of 80.0 MPa was applied to this multilayer body, whereby a positive electrode was formed.

Current collectors formed of stainless steel were placed on the positive electrode and the negative electrode, and current collection leads were attached to these current collectors.

Finally, the inside of the electrically insulating cylinder was protected from the outside atmosphere using an electrically insulating ferrule, whereby the inside of the cylinder was tightly sealed. In such a manner, a battery of Example 1 was obtained.

### Example 2

A coated active material was obtained as an active material sample of Example 2 in the same manner as in Example 1, except that the solution was prepared by dissolving 2.9 g of polyvinyl alcohol in the aqueous solution of lithium hydroxide instead of 2.9 g of sucrose. It should be noted that the solubility of the polyvinyl alcohol used in 100 mL of water at 25° C. is higher than or equal to 0.1 g. The pH of the prepared solution, furthermore, was 14.

### Measurement of Electronic Conductivity

Electronic conductivity of the active material sample of Example 2 was measured in the same manner as in Example 1. The electronic conductivity of the active material sample of Example 2 was 1.04×10⁻³ S/cm.

### Preparation of a Negative Electrode Material

A negative electrode material of Example 2 was obtained in the same manner as in Example 1, except that the active material sample of Example 2 was used.

### Fabrication of a Secondary Battery

A battery of Example 2 was obtained in the same manner as in Example 1, except that the negative electrode material of Example 2 was used.

### Comparative Example 1

A 5.0 mol/L aqueous solution of sodium hydroxide was prepared by dissolving 16.0 g of sodium hydroxide in 80 mL of water. Preparation of a solution of 2.9 g of sucrose in this aqueous solution of sodium hydroxide was attempted, but a white precipitate was observed. The pH of this mixture was 14. By immersing 1 g of powder of LVO in this mixture containing a white precipitate, a slurry was obtained. Except for these, the same operations as in Example 1 were performed, whereby an active material sample of Comparative Example 1 was obtained.

### Measurement of Electronic Conductivity

Electronic conductivity of the active material sample of Comparative Example 1 was measured in the same manner as in Example 1. The electronic conductivity of the active material sample of Comparative Example 1 was unmeasurable; it was less than 1.00×10⁻¹⁰ S/cm.

### Preparation of a Negative Electrode Material

A negative electrode material of Comparative Example 1 was obtained in the same manner as in Example 1, except that the active material sample of Comparative Example 1 was used.

### Fabrication of a Secondary Battery

A battery of Comparative Example 1 was obtained in the same manner as in Example 1, except that the negative electrode material of Comparative Example 1 was used.

### Comparative Example 2

A 5.0 mol/L aqueous solution of potassium hydroxide was prepared by dissolving 22.5 g of potassium hydroxide in 80 mL of water. Preparation of a solution of 2.9 g of sucrose in this aqueous solution of potassium hydroxide was attempted, but a white precipitate was observed. The pH of this mixture was 14. By immersing 1 g of powder of LVO in this mixture containing a white precipitate, a slurry was obtained. Except for these, the same operations as in Example 1 were performed, whereby an active material sample of Comparative Example 2 was obtained.

Electronic conductivity of the active material sample of Comparative Example 2 was measured in the same manner as in Example 1. The electronic conductivity of the active material sample of Comparative Example 2 was unmeasurable; it was less than 1.00×10⁻¹⁰ S/cm.

### Preparation of a Negative Electrode Material

A negative electrode material of Comparative Example 2 was obtained in the same manner as in Example 1, except that the active material sample of Comparative Example 2 was used.

### Fabrication of a Secondary Battery

A battery of Comparative Example 2 was obtained in the same manner as in Example 1, except that the negative electrode material of Comparative Example 2 was used.

### Comparative Example 3

An 80 mL portion of a 5.0 mol/L aqueous solution of ammonia was prepared instead of a 5.0 mol/L aqueous solution of lithium hydroxide. By dissolving 2.9 g of sucrose in this aqueous solution of ammonia, a solution was prepared. The pH of this solution was 11. By immersing 1 g of powder of LVO in this solution, a slurry was obtained. Except for these, the same operations as in Example 1 were performed, whereby an active material sample of Comparative Example 3 was obtained.

Electronic conductivity of the active material sample of Comparative Example 3 was measured in the same manner as in Example 1. The electronic conductivity of the active material sample of Comparative Example 3 was 1.52×10⁻⁸ S/cm.

### Preparation of a Negative Electrode Material

A negative electrode material of Comparative Example 3 was obtained in the same manner as in Example 1, except that the active material sample of Comparative Example 3 was used.

### Fabrication of a Secondary Battery

A battery of Comparative Example 3 was obtained in the same manner as in Example 1, except that the negative electrode material of Comparative Example 3 was used.

### Comparative Example 4

An 80 mL portion of a 5.0 mol/L aqueous solution of dimethylamine was prepared instead of a 5.0 mol/L aqueous solution of lithium hydroxide. By dissolving 2.9 g of sucrose in this aqueous solution of dimethylamine, a solution was prepared. The pH of this solution was 12. By immersing 1 g of powder of LVO in this solution, a slurry was obtained. Except for these, the same operations as in Example 1 were performed, whereby an active material sample of Comparative Example 4 was obtained.

Electronic conductivity of the active material sample of Comparative Example 4 was measured in the same manner as in Example 1. The electronic conductivity of the active material sample of Comparative Example 4 was 9.89×10⁻¹⁰ S/cm.

### Preparation of a Negative Electrode Material

A negative electrode material of Comparative Example 4 was obtained in the same manner as in Example 1, except that the active material sample of Comparative Example 4 was used.

### Fabrication of a Secondary Battery

A battery of Comparative Example 4 was obtained in the same manner as in Example 1, except that the negative electrode material of Comparative Example 4 was used.

### Comparative Example 5

A 0.010 mol/L aqueous solution of lithium hydroxide was prepared by dissolving 0.019 g of lithium hydroxide in 80 mL of water. By dissolving 2.9 g of sucrose in this aqueous solution of lithium hydroxide, a solution was prepared. The pH of this solution was 9. By immersing 1 g of powder of LVO in this solution, a slurry was obtained. After the slurry was stirred for approximately 30 minutes, the solution was filtered using a membrane filter having a pore size of 1 μm. However, no active material sample was obtained because all of the LVO was dissolved in the water.

### Comparative Example 6

A solution was prepared by dissolving 2.9 g of sucrose in 80 mL of water. The pH of this solution was 7. By immersing 1 g of powder of LVO in this solution, a slurry was obtained. After the slurry was stirred for approximately 30 minutes, the solution was filtered using a membrane filter having a pore size of 1 μm. However, no active material sample was obtained because all of the LVO was dissolved in the water.

### Charge-Discharge Measurement

Initial charge-discharge characteristics of the batteries of Examples 1 and 2 and Comparative Examples 1 to 4 were measured by the following method. It should be noted that the fabricated batteries were cells for charge-discharge testing and corresponded to negative-electrode half cells. In the examples, therefore, charging refers to a state in which current flows in the direction in which lithium ions move from metallic Li(i.e., the positive electrode as described above) to the negative electrode, and discharging refers to a state in which current flows in the direction in which lithium ions move from the negative electrode to metallic Li(i.e., the positive electrode as described above). That is, the direction in which the potential of the half cell decreases is referred to as charging, and the direction in which the potential increases is referred to as discharging.

Each battery was placed in a temperature-controlled chamber at 25° C.

The battery was charged at a current density of 78 μA/cm² until the negative electrode reached a voltage of 0.30 V relative to the positive electrode. This current density corresponds to a 0.05 C rate (20-hour rate) relative to the theoretical capacity of the battery.

Then the battery was discharged at a current density of 78 μA/cm² until the negative electrode reached a voltage of 2.50 V relative to the positive electrode. This current density corresponds to a 0.05 C rate (20-hour rate) relative to the theoretical capacity of the battery.

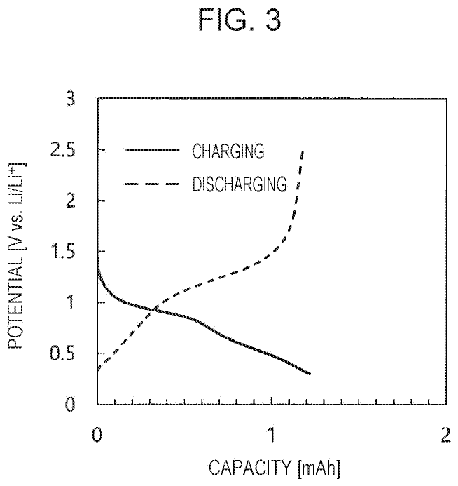

As a result of the charge-discharge measurement, it was found that the battery according to Example 1 had an initial charge capacity of 1.22 mAh. FIG. 3 is a graph representing initial charge-discharge characteristics of the battery of Example 1.

The battery according to Example 2 had an initial charge capacity of 1.12 mAh.

The battery according to Comparative Example 1 had an initial charge capacity of 0.135 mAh.

The battery according to Comparative Example 2 had an initial charge capacity of 0.167 mAh.

The battery according to Comparative Example 3 had an initial charge capacity of 0.177 mAh.

The battery according to Comparative Example 4 had an initial charge capacity of 0.173 mAh.

TABLE 1

| | | | LiOH/water by | | Electronic | Charge |
|---|---|---|---|---|---|---|
| | Active | Base | mass | Organic | conductivity | capacity |
| | material | source | [% by mass] | substance | [S/cm] | [mAh] |
| Example 1 | LVO | LiOH | 12 | Sucrose | 9.00 × 10⁻² | 1.22 |
| Example 2 | LVO | LiOH | 12 | Polyvinyl | 1.04 × 10⁻³ | 1.12 |
| | | | | alcohol | | |
| Comparative | LVO | NaOH | 0 | Sucrose | <1.00 × 10⁻¹⁰ | 0.135 |
| Example 1 | | | | | | |
| Comparative | LVO | KOH | 0 | Sucrose | <1.00 × 10⁻¹⁰ | 0.167 |
| Example 2 | | | | | | |
| Comparative | LVO | NH₃ | 0 | Sucrose | 1.52 × 10⁻⁸ | 0.177 |
| Example 3 | | | | | | |
| Comparative | LVO | (CH₃)₂NH | 0 | Sucrose | 9.89 × 10⁻¹⁰ | 0.173 |
| Example 4 | | | | | | |
| Comparative | LVO | LiOH | 0.024 | Sucrose | — | — |
| Example 5 | | | | | | |
| Comparative | LVO | — | 0 | Sucrose | — | — |
| Example 6 | | | | | | |

### Discussion

When Examples 1 and 2 and Comparative Examples 1 to 4 in Table 1 are compared, the batteries of Examples 1 and 2 exhibited higher charge capacities. In Comparative Examples 1 to 4, in which lithium hydroxide was replaced with a different base source, the charge capacity decreased compared with Example 1. The inventors believe that for Comparative Examples 1 and 2, these results are because the sucrose formed a precipitate with the base source, rather than coating the surface of LVO with carbon, resulting in failure to improve the electronic conductivity of the active material, and because dissolved cations other than Li ions covered the surface of LVO and inhibited conduction of Li ions, resulting in increased electrode resistance. For Comparative Examples 3 and 4, the above results appear to be because the base source was not a strong base. The low pH of the slurry used to prepare the coated active material made it difficult for the LVO to maintain its structure, preventing the surface of LVO from being appropriately coated with carbon. As a result, the inventors believe, the electronic conductivity of the active material did not improve.

In Comparative Examples 5 and 6, no coated active material was collected due to complete dissolution of LVO. The inventors believe that this is because the percentage by mass of lithium hydroxide relative to water was less than 10%, and, as a result, the LVO was no longer able to maintain its structure.

### INDUSTRIAL APPLICABILITY

A battery according to an aspect of the present disclosure can be used as, for example, an all-solid-state lithium secondary battery.

What is claimed is:

1. A composition comprising:
water;
lithium hydroxide;
at least one organic substance that has no carboxyl group and that dissolves in water; and
at least one active material containing element V, wherein:
a percentage of the lithium hydroxide relative to the water is greater than or equal to 10% as a percentage by mass.

2. The composition according to claim 1, wherein:
the organic substance includes at least one saccharide.

3. The composition according to claim 2, wherein:
the saccharide is at least one saccharide selected from the group consisting of monosaccharides and disaccharides.

4. The composition according to claim 1, wherein:
the organic substance includes at least one polymeric compound.

5. The composition according to claim 4, wherein:
the polymeric compound is at least one selected from the group consisting of polyvinyl alcohol, polyvinyl butyral, carboxymethyl cellulose, and ethyl cellulose.

6. The composition according to claim 5, wherein:
the active material is a compound represented by formula (1), 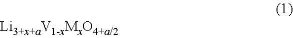
where:
the M is at least one element selected from the group consisting of tetravalent metal elements and tetravalent metalloid elements; and
the formula (1) satisfies 0≤a<1 and 0≤x<1.

7. The composition according to claim 6, wherein:
the formula (1) satisfies 0≤x≤0.15.

8. The composition according to claim 6, wherein:
the M includes Ti.

9. A method for manufacturing a coated active material, the method comprising:
(A) drying the composition according to claim 1.

10. The method according to claim 9 for manufacturing a coated active material, the method further comprising:
(B) carbonizing the organic substance by heat treatment.

11. A method for manufacturing a battery including
a first electrode,
a second electrode, and
an electrolyte layer disposed between the first electrode and the second electrode,
the method comprising:
(A) drying the composition according to claim 1; and
(B) carbonizing the organic substance by heat treatment
in forming the first electrode.

12. A battery comprising:
a first electrode;
a second electrode; and
an electrolyte layer disposed between the first electrode and the second electrode, wherein:
the first electrode contains the composition according to claim 1.

13. The battery according to claim 12, wherein:
the first electrode further contains a conductive additive.
